(19) United States
(12) Patent Application Publication
(10) Pub. No.: US 2013/0247572 A1
(43) Pub. Date: Sep. 26, 2013

(54) MAGNETIC THERMAL DEVICE

(71) Applicants: Chung-Jung KUO, Taoyuan Hsien (TW); Ming-Han Lin, Taoyuan Hsien (TW); Tze-Chern Mao, Taoyuan Hsien (TW); Ming-Tsz Lin, Taoyuan Hsien (TW); Chieh-Cheng Liu, Taoyuan Hsien (TW); Jiun-Lin Wu, Taoyuan Hsien (TW)

(72) Inventors: Chung-Jung KUO, Taoyuan Hsien (TW); Ming-Han Lin, Taoyuan Hsien (TW); Tze-Chern Mao, Taoyuan Hsien (TW); Ming-Tsz Lin, Taoyuan Hsien (TW); Chieh-Cheng Liu, Taoyuan Hsien (TW); Jiun-Lin Wu, Taoyuan Hsien (TW)

(73) Assignee: DELTA ELECTRONICS, INC., Taoyuan Hsien (TW)

(21) Appl. No.: 13/429,100

(22) Filed: Mar. 23, 2012

(51) Int. Cl. F03G 7/00

(52) U.S. Cl. 60/721

(57) ABSTRACT

A magnetic thermal device is provided. The magnetic thermal device includes a shaft, having an axis direction; a rotator, supported by the shaft, having a working material and a utility material; a magnetic assembly, adjacent to the rotator, for generating a magnetic flux passing through the rotator in a flux direction, wherein the flux direction is substantially perpendicular to the axis direction.

### CROSS REFERENCE TO RELATED APPLICATIONS

### Background of the Invention

1. Field of the Invention

The present invention relates to a magnetic thermal device having more stable rotation speed and larger output torque.

2. Description of the Related Art

A magnetic thermal engine is a machine designed to cause mechanical motion by taking advantage of magnetocaloric effect.

FIG. 1 shows a magnetic thermal engine in the prior art. As shown in FIG. 1, the magnetic thermal engine 100 includes a shaft 110, a rotator 120, magnets 140, a hot water supply 150 and a cooling zone 160. The rotator 120 is a hollow disc having a working material 122 on its rim. The working material 122, which is usually made of a magnetic material, can produce a significant change in magnetic field if its temperature is properly changed. The hot water supply 160 and the cooling zone 150 respectively heats up and cools down two different areas of the rotator 120 which has the working material 122 as shown in FIG. 1, thus producing two magnetic fields with different magnitudes thereon. Then, the two areas of the rotator 120 have a net magnetic moment (or torque) in relation to the magnets 140, and the net magnetic moment collectively rotates the rotator 120 in a particular direction by the shaft 110.

However, this hollow disc design has a large air gap, and thus in some degree blocks the magnetic path and therefore increases the magnetic reluctance in the magnetic thermal engine 100. In addition, it is difficult for the rotator 120 of the magnetic thermal engine 100 in the prior art to rotate in a stable way due to the asymmetric configuration of the magnets 140 as shown in FIG. 1, and the unstable motion greatly reduces the robustness of the entire structure.

### BRIEF SUMMARY OF THE INVENTION

The present invention provides a magnetic thermal device. The magnetic thermal device includes a shaft, having an axis direction; a rotator, supported by the shaft, having a working material and a utility material; a magnetic assembly, adjacent to the rotator, for generating a magnetic flux passing through the rotator in a flux direction, wherein the flux direction is substantially perpendicular to the axis direction.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a magnetic thermal engine in the prior art.

FIG. 2A is a diagram showing a magnetic thermal device 200 according to an embodiment of the present invention, and FIG. 2B is the lateral view of the magnetic thermal device 200 of FIG. 2A.

FIG. 3 is a diagram showing a magnetic thermal device 300 according to an embodiment of the present invention.

FIG. 4 is a diagram showing a magnetic thermal device 400 according to an embodiment of the present invention.

FIG. 5 is a diagram showing a magnetic thermal device 500 according to an embodiment of the present invention.

FIG. 6 is a diagram showing a magnetic thermal device 600 according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

To overcomes the defects of the prior art, the present invention provides various magnetic thermal devices which not only improve rotation stability but also increase rotation torque thereof. These embodiments will be further described in detail in the following paragraphs.

### Embodiment 1

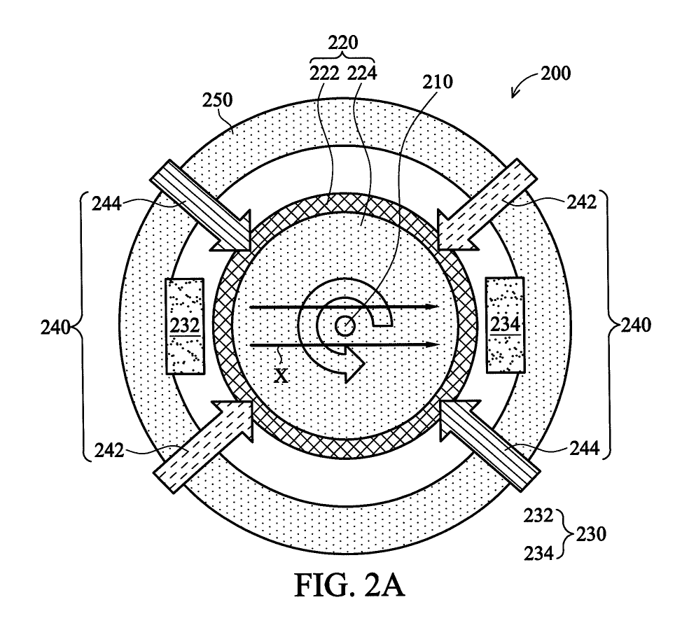

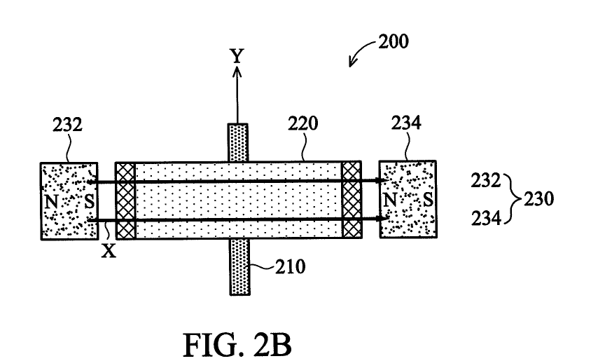

FIG. 2A is a diagram showing a magnetic thermal device 200 according to an embodiment of the present invention, and FIG. 2B is the lateral view of the magnetic thermal device 200 of FIG. 2A. The magnetic thermal device 200 of the present invention has a shaft 210, a rotator 220, a magnetic assembly 230, a heat exchanging assembly 240, and a stator 250, where the rotator 220 rotates inside the stator 250.

The shaft 210 supports the rotator 220, and the rotator 220 pivots the shaft 210. The rotator 220, in a shape of a disk (or plate) in this embodiment, is mainly made from a utility material 224, which will be discussed later, and has a working material 222 disposed on the edge (or rim) of the disk. In the present invention, the working material 222 is, for example, a magneto-caloric material having a Curie temperature Tc, such as, FeRh, Gd₅Si₂, RCo₂, La(Fe, Si)₁₃, MnA₁₋ₓSbₓ, MnFe(P,As), Co(S₁₋ₓSeₓ)₂, NiMnSn, MnCoGeB, . . . , or other material having similar magnetic characteristics.

In this embodiment, the magnetic assembly 230 has a pair of magnetic elements 232 and 234 adjacent to the rotator 220. For example, the pair of magnetic elements 232 and 234 are disposed on two sides of the rotator 220 and opposite to each other, as shown in FIG. 2. The magnetic assembly 230 of the present invention is used for generating a magnetic flux passing through the rotator 220, especially the working material 224 of the rotator 220, for inducing the magnetic field thereon so as to drive the rotator 220.

As shown in FIG. 2A, the heat exchanging assembly 240 has at least one hot source 242 and at least one cold source 244 disposed on two opposite sides of one of the magnetic elements 232 and 234 (for the magnetic element 232, shown in left part of FIG. 2A, a hot source 242 is on the lower side while a cold source 244 is on the upper side thereof, and for the magnetic element 234, shown in right part of FIG. 2A, a cold source 244 is on the lower side while a hot source 242 is on the upper side thereof). Although two hot sources 242 and two cold sources 244 are shown in FIG. 2A, it should be noted the number and the arrangement of the hot sources and/or cold sources are not limited, as long as they are all arranged in an interlaced pattern in this embodiment. The heat exchanging assembly 240 is used for exchanging heat with the working material 224, for example, by injecting a heat exchanging medium, such as air, vapor, spray, oiliness liquid, hydrophilic liquid, hybrid liquid, or combination thereof, on the rotator 220. Specifically, for the magnetic element 232, shown in left part of FIG. 2A, the hot source 242 heats up the working material 224 near the lower side of the magnetic element 232, and thus decreases the magnetic field of a potion of the working material 224 and a force that pushes the rotator 220 thereof, while the cold source 244 cools down the working material 224 near the upper side of the magnetic element 232, and thus increases the magnetic field of another potion of the working material 224 and another force pushes the rotator 220 thereof. The difference between the two forces applied to the two different portions of the working material 224 on the rim of the rotator 220, and thus collectively rotates the rotator 220 in a counterclockwise direction as shown in FIG. 2A. In a better embodiment, those skilled in the art can appreciate that the hot source and the cold source 242 and 244 should be disposed as close to the magnetic elements 232 as possible to produce a greater magnetic torque for the rotator 220.

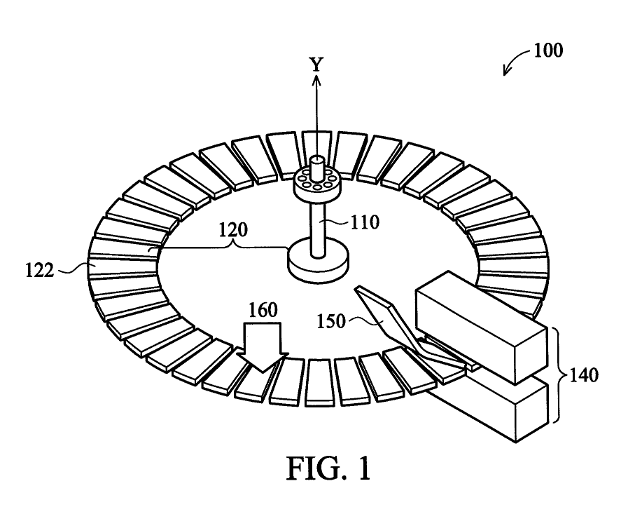

Note that the arrangement of the magnetic assembly 230 in the present invention is totally different from that in the prior art. In the prior art as shown in FIG. 1, the magnetic flux generated by the magnets 140 and the shaft 110 are all along the same direction (Y direction). However, as shown in FIG. 2B, the shaft 210 of the present invention is along an axis direction (Y direction), while the magnetic flux generated by the magnetic assembly 230 is along a flux direction (X direction) which is substantially perpendicular to the axis direction (Y direction). In the present invention, the magnetic flux produced by the magnetic assemble 230 will not form any force components in a perpendicular direction (Y direction), thus getting rid of the interferences to the rotation of the rotator 220, and stabilizing the entire structure of the magnetic thermal device 200.

In addition, it should be noted that the use of the utility material 222 in the rotator 220 in the present invention is also different from that in the prior art. The utility material 222 in the present invention has high magnetic permeability, such as a pure iron, silicon steel, or low carbon steel. Instead of the hollow structure of the rotator 110 as shown in FIG. 1, the present invention uses the utility material 222 with high magnetic permeability as the main structural material of the rotator 220, and thus reduces the space of the air gap as much as possible (the existence of the air gap blocks the magnetic flux and twists the magnetic circuit as well). The use of the utility material 222 with high magnetic permeability is beneficial for the magnetic flux generated by the magnetic assembly 230 to pass through the rotator 220 much easier, and thus produce greater rotation torque effectively. Moreover, the use of the utility material 222 with high magnetic permeability increases the inertia of the rotator 220, and thus helps the rotator 220 to achieve stable rotation (which is so called “flywheel effect”). In a better embodiment, the high magnetic permeability material is not limited to be only used in the rotator 22, where the stator 250, the shaft 210, and any support of the rotator 210 can also be made from the high magnetic permeability material for further improving the rotation stability and rotation speed of the magnetic thermal device 200.

There are various modifications for the magnetic thermal device of the present invention, and some of them will be described in the following embodiments.

### Embodiment 2

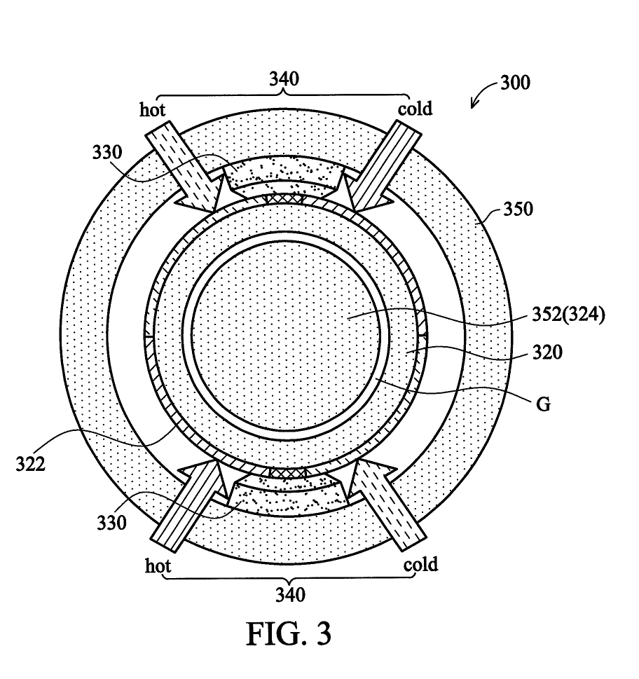

FIG. 3 is a diagram showing a magnetic thermal device 300 according to an embodiment of the present invention. Similarly, the magnetic thermal device 300 of the present invention has a shaft (not shown), a rotator 320 having a working material 324 a magnetic assembly 330, a heat exchanging assembly 340, and an external stator 350 an internal stator 352. The working material 324 is a magneto-caloric material having a Curie temperature, such as, FeRh, Gd₅Si₂, RCo₂, La(Fe, Si)₁₃, MnA₁₋ₓSbₓ, MnFe(P,As), Co(S₁₋ₓSeₓ)₂, NiMnSn, MnCoGeB, . . . , or other material having similar magnetic characteristics. The magnetic assembly 330 and the heat exchanging assembly 340 are arranged in the same manner and have the same use as that in Embodiment 1.

However, in this embodiment, the internal stator 352 is made from the utility material (i.e., high magnetic permeability material) 324 and is much larger than that in Embodiment 1. For lowering the weight of the rotator 320, the rotator 320 in this embodiment is hollow and covered by working material 322. For the rotation of the rotator 320, there is an extremely small gap G which separates the rotator 320 from the internal stator 352. Since air is a relative low magnetic permeability material, those skilled in the art can appreciate that the smaller the gap G, the better of the magnetic thermal device 300 performs.

### Embodiment 3

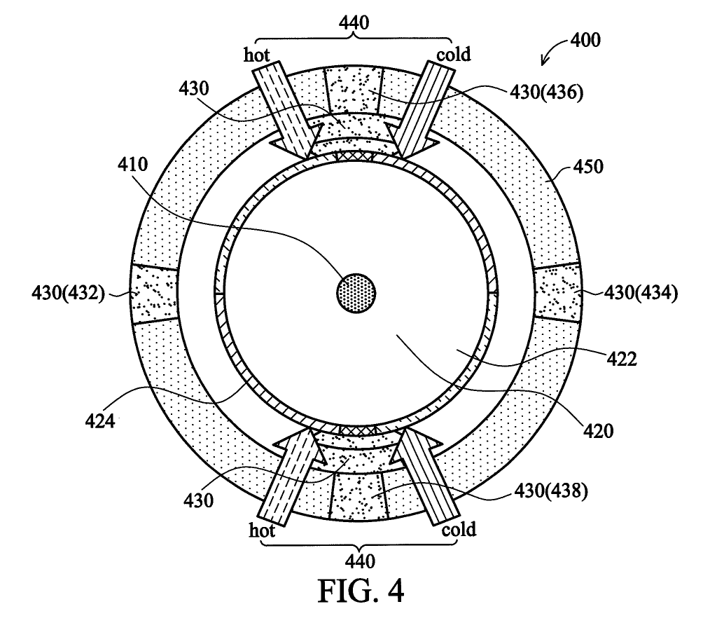

FIG. 4 is a diagram showing a magnetic thermal device 400 according to an embodiment of the present invention. Similarly, the magnetic thermal device 400 of the present invention has a shaft 410, a rotator 420 which is mainly made from a utility material 422 and has a working material 424 disposed on the edge, a magnetic assembly 430, a heat exchanging assembly 440, and a stator 450. The utility material 422 is a high magnetic permeability material, and the working material 424 is a magneto-caloric material having a Curie temperature, such as, FeRh, Gd₅Si₂, RCo₂, La(Fe, Si)₁₃, MnA₁₋ₓSbₓ, MnFe(P,As), Co(S₁₋ₓSeₓ)₂, NiMnSn, MnCoGeB, . . . , or other material having similar magnetic characteristics. The heat exchanging assembly 440 is arranged in the similar manner, and has the similar use as that in Embodiment 1.

However, the magnetic assembly 430 in this embodiment has four magnetic elements 432, 434, 436 and 438. In this embodiment, these four magnetic elements 432, 434, 436 and 438 are spaced apart from one another by an angle of 90 degrees. In another embodiment, the magnetic assembly 430 can comprise N magnet elements, which are spaced apart from one another by an angle ranging from 180/N to 360/N degrees (N is an integer equal to or larger than 2, and is preferably an even integer). Those skilled in the art can appreciate that no matter how many magnet elements there are in the magnetic thermal device, the magnetic flux generated by the magnet elements passes through the rotator in a flux direction which is substantially perpendicular to the axis direction of the shaft, and makes the rotator rotate in a stable manner.

### Embodiment 4

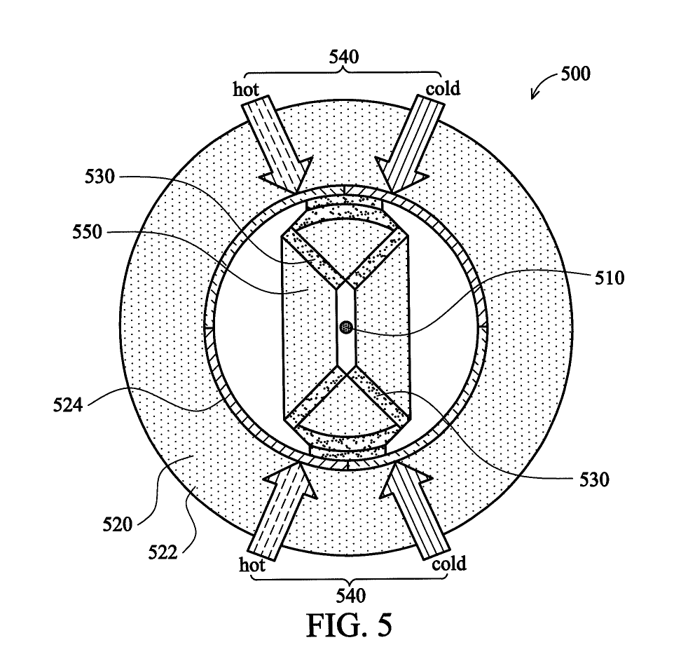

FIG. 5 is a diagram showing a magnetic thermal device 500 according to an embodiment of the present invention. In this embodiment, the rotator 520 rotates outside of the stator 550. The magnetic thermal device 500 basically has the same feature as that in the previous embodiments, such as, the magnetic flux generated by the magnetic assembly 530 passes through the rotator 520 in a flux direction substantially perpendicular to the axis direction of the shaft 510, and the shaft 510, the rotator 520, and the stator 550 are mainly made from the utility material 522 which has high magnetic permeability. The utility material 522 is a high magnetic permeability material, and the working material 524 is a magneto-caloric material having a Curie temperature, such as, FeRh, Gd₅Si₂, RCo₂, La(Fe, Si)₁₃, MnA₁₋ₓSbₓ, MnFe(P,As), Co(S₁₋ₓSeₓ)₂, NiMnSn, MnCoGeB, . . . , or other material having similar magnetic characteristics. The heat exchanging assembly 540 is arranged and operated in substantially the same manner as that in the previous embodiments.

### Embodiment 5

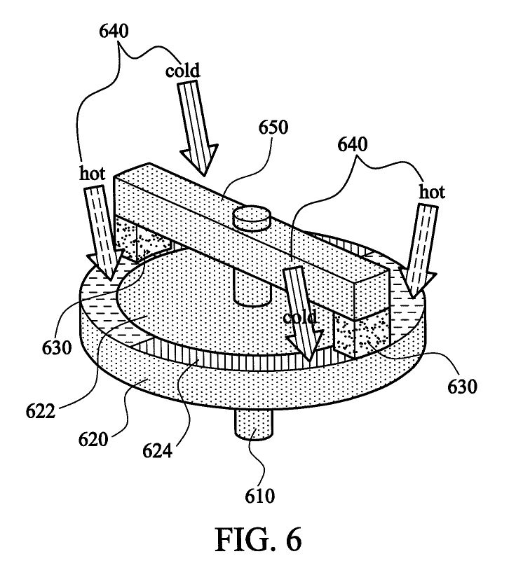

FIG. 6 is a diagram showing a magnetic thermal device 600 according to an embodiment of the present invention. Similarly as aforementioned, the magnetic thermal device 600 of the present invention has a shaft 610, a rotator 620 which is mainly made from a utility material 622 and has a working material 624 disposed on the edge, a magnetic assembly 630, a heat exchanging assembly 640, and a stator 650. The utility material 622 is a high magnetic permeability material, and the working material 624 is a magneto-caloric material having a Curie temperature, such as, FeRh, Gd₅Si₂, RCo₂, La(Fe, Si)₁₃, MnA₁₋ₓSbₓ, MnFe(P,As), Co(S₁₋ₓSeₓ)₂, NiMnSn, MnCoGeB, . . . , or other material having similar magnetic characteristics. The heat exchanging assembly 640 is arranged and operated in substantially the same manner as that in the previous embodiments.

In the previous embodiment, the magnetic assembly 630 and the rotator 620 are disposed in the same plane level. Differently, in this embodiment, the magnetic assembly 630 has a slightly higher position than the rotator 620. However, it should be noted that although the position of the magnetic assembly 630 is different from that in the previous embodiments, the magnetic flux generated by the magnetic assembly 630 still passes through the rotator 620 in a flux direction substantially perpendicular to the axis direction of the shaft 610.

Various magnetic thermal devices 200˜600 shown in FIGS. 3 to 6 have bee fully described above. The magnetic thermal devices 200˜600 of the present invention can recover the waste heat and generate power or electricity. Therefore, it is appropriate for the magnetic thermal devices 200˜600 to be used in a waste heat recover system such as in power plant, factory, office building, central air conditioner, or garbage furnace.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A magnetic thermal device, comprising:
a shaft, having an axis direction;
a rotator, supported by the shaft, having a working material and a utility material;
a magnetic assembly, adjacent to the rotator, for generating a magnetic flux passing through the rotator in a flux direction, wherein the flux direction is substantially perpendicular to the axis direction.

2. The magnetic thermal device as claimed in claim 1, wherein the working material is a magneto-caloric material having a Curie temperature.

3. The magnetic thermal device as claimed in claim 2, further comprising:
at least one heat exchanging assembly for exchanging heat with the working material.

4. The magnetic thermal device as claimed in claim 3, wherein the heat exchanging assembly further comprises:
a hot source for heating up the working material; and
a cold source for cooling down the working material.

5. The magnetic thermal device as claimed in claim 3, wherein the heat exchanging assembly further comprises a heat exchanging medium, wherein the heat exchanging medium is selected from the group consisting of air, vapor, spray, oiliness liquid, hydrophilic liquid, hybrid liquid, and combination thereof.

6. The magnetic thermal device as claimed in claim 1, wherein the magnetic assembly comprises a pair of magnetic elements disposed on two sides of the rotator.

7. The magnetic thermal device as claimed in claim 1, wherein the magnetic assembly comprises N magnet elements spaced apart from one another by an angle, wherein N is an even integer equal to or larger that 2.

8. The magnetic thermal device as claimed in claim 7, wherein the angle ranges from 180/N to 360/N degrees.

9. The magnetic thermal device as claimed in claim 1, wherein the utility material has high magnetic permeability.
